(19) United States
(12) Patent Application Publication
(10) Pub. No.: US 2002/0194228 A1
(43) Pub. Date: Dec. 19, 2002

(54) System and method for automated rendering to print to a file

(76) Inventors: Lainye Reich, Vancouver, WA (US); Jeremy Bunn, Kelso, WA (US); Daniel Revel, Portland, OR (US)

Correspondence Address: HEWLETT-PACKARD COMPANY, Intellectual Property Administration, P.O. Box 272400, Fort Collins, CO, 80527-2400, US

(21) Appl. No.: 09/884,249

(22) Filed: Jun. 18, 2001

(51) Int. Cl. G06F 17/21

(52) U.S. Cl. 707/526; 707/523

(57) ABSTRACT

An automated rendering system and method are provided. In one embodiment, the system comprises a processor circuit having a processor and a memory. Stored in the memory and executable by the processor is a rendering service that comprises logic that identifies an application employed to generate a digital document in a computer system, and logic that identifies a select rendering application from a number of rendering applications in the computer system to render the document into an output file embodied in a predefined file format. The rendering service further comprises logic that automatically executes the select rendering application to render the digital document into the output file embodied in the predefined file format.

### TECHNICAL FIELD

The present invention is generally related to the field of printing and, more particularly, is related to a system and method for automatically rendering to print to a file.

### BACKGROUND OF THE INVENTION

Recent years have seen a proliferation of portable electronic devices such as personal digital assistants (PDA's), cellular telephones, and/or other portable electronic devices. For example, personal digital assistants are now available such as the HP Jornada manufactured by Hewlett-Packard Company based in Palo Alto, Calif., or the Blackberry™ manufactured by Research in Motion™ Limited based in Ontario, Canada as well as other brands. These mobile devices offer a range of capabilities, including mobile calendars, organizing capabilities, and electronic mail (email) received and transmitted via a mobile pager network or other mobile networks, etc.

Unfortunately, these devices are typically limited in their capabilities due to the fact that they are limited in their processing capacity and memory size. For example, many such devices cannot execute the many different applications that are available for the average personal computer. Specifically, such devices may not be able to implement word processors or other extensive applications.

When it comes to activities such as printing, etc., such devices typically are unable to perform various tasks such as rendering documents in printer compatible form, etc. This fact can negatively impact the usefulness of such devices. For example, a user may find themselves in the situation where they are standing in front of a printer with their personal digital assistant in hand and a document stored thereon that they wish to print. Unfortunately, in such a circumstance, the user may be prevented from printing a document with the printer due to the limited capability of the personal digital assistant and the lack of connectivity between the printer and the personal digital assistant.

In yet another situation, a user may have a laptop computer that has the computing capacity to perform the tasks necessary to print a document. However, the user may be in a location where they do not have access to their usual printer. In such a case, the user may be prevented from printing to any available printer because it is a different model that requires a rendering application that is not stored on their laptop. Also, in some cases the user may wish to print a document that was created using an application that the user does not have on the laptop. The user may be prevented from printing such a document as the missing application may be necessary to render the document for printing.

### SUMMARY OF THE INVENTION

In view of the foregoing, the present invention provides for an automated rendering system and method. In one embodiment, the system comprises a processor circuit having a processor and a memory. Stored in the memory and executable by the processor is a rendering service that comprises logic that identifies an application employed to generate a digital document in a computer system, and logic that identifies a select rendering application from a number of rendering applications in the computer system to render the document into an output file embodied in a predefined file format. The rendering service further comprises logic that automatically executes the select rendering application to render the digital document into the output file embodied in the predefined file format.

In another embodiment, a rendering method is provided comprising the steps of identifying an application employed to generate a digital document in a computer system, identifying a select rendering application from a number of rendering applications in the computer system to render the document into an output file embodied in a predefined file format, and, automatically rendering the digital document into the output file embodied in the predefined file format with the select rendering application.

The present invention further provides for a program embodied in a computer readable medium for document rendering. In this regard, the program comprises code that identifies an application employed to generate a digital document in a computer system, code that identifies a select rendering application from a number of rendering applications in the computer system to render the document into an output file embodied in a predefined file format, and, code that automatically executes the select rendering application to render the digital document into the output file embodied in the predefined file format.

Other features and advantages of the present invention will become apparent to a person with ordinary skill in the art in view of the following drawings and detailed description. It is intended that all such additional features and advantages be included herein within the scope of the present invention.

### BRIEF DESCRIPTION OF THE SEVERAL VIEWS OF THE DRAWINGS

The invention can be understood with reference to the following drawings. The components in the drawings are not necessarily to scale. Also, in the drawings, like reference numerals designate corresponding parts throughout the several views.

FIG. 1 is a block diagram of a remote rendering network according to an aspect of the present invention;

FIG. 2 is a block diagram of a rendering service executed in a server in the remote rendering network of FIG. 1;

FIG. 3 is a block diagram of a first rendering branch employed by the rendering service of FIG. 2;

FIG. 4 is a flow chart of a document rendering module employed in the rendering service of FIG. 2;

FIG. 5 is a flow chart of a first rendering controller employed in the first rendering branch of FIG. 3;

FIG. 6 is a block diagram of a second rendering branch employed by the rendering service of FIG. 2; and

FIG. 7 is a flow chart of a second rendering controller employed in the second rendering branch of FIG. 6.

### DETAILED DESCRIPTION OF THE INVENTION

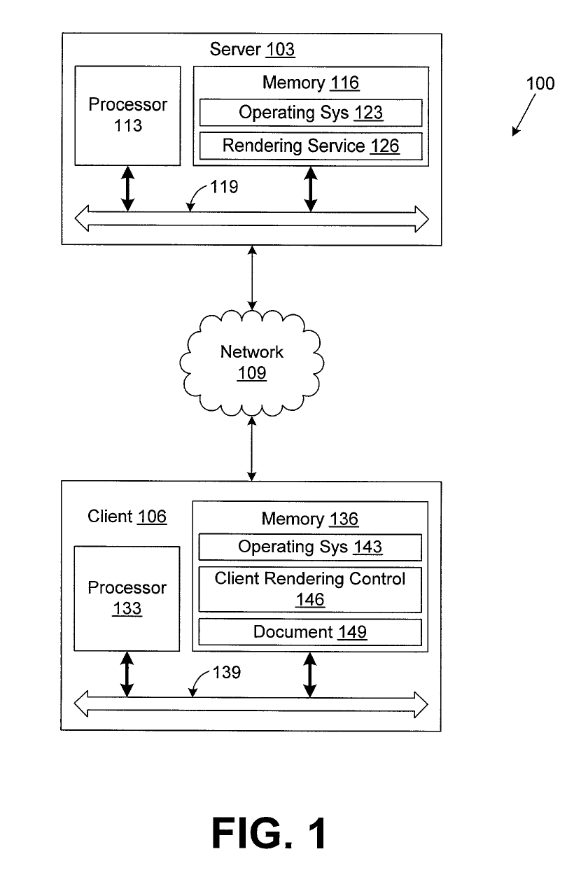

With reference to FIG. 1, shown is a remote rendering network 100 according to an aspect of the present invention. With regard to the following discussion, first the physical makeup of the remote rendering network 100 is described followed with a discussion of the operation of the remote rendering network 100.

The remote rendering network 100 includes a server 103, and a client 106, both of which are coupled to a network 109. In this respect, the server 103 and the client 106 may comprise, for example, computer systems or other systems with like capability. The server 103 includes a processor circuit with a processor 113 and a memory 116, both of which are coupled to a local interface 119. The local interface 119 may be, for example, a data bus with an accompanying control/address bus as is generally understood by those with ordinary skill in the art. Stored on the memory 116 and executable by the processor 113 are an operating system 123 and a rendering service 126. The specific operation of the rendering service 126 is discussed in greater detail in the discussion that follows.

The client 106 includes a processor 133 and a memory 136, both of which are coupled to a local interface 139. The local interface 139 may comprise, for example, a data bus with an accompanying control bus as is generally known by those with ordinary skill in the art. Stored on the memory 136 and executable by the processor 133 is an operating system 143, a client rendering control 146, and one or more documents 149.

The network 109 includes, for example, the Internet, wide area networks (WANs), local area networks, or other suitable networks, etc., or any combination of two or more such networks. The server 103 and the client 106 are coupled to the network 109 so as to facilitate data communication to and from the network 109 in any one of a number of ways that are generally known by those of ordinary skill in the art. For example, the server 103 and the client 106 may be linked to the network 109 through various devices such as, for example, network interface cards, modems, or other such communications devices.

Also, various peripheral devices may be employed with the server 103 and the client 106 such as, for example, keyboards, keypads, touch pads, touch screens, microphones, scanners, a mouse, joysticks, or one or more push buttons, etc. The peripheral devices may also include display devices, indicator lights, speakers, printers, etc. Specific display devices may be, for example, cathode ray tubes (CRT), liquid crystal display screens, gas plasma-based flat panel displays, or other types of display devices, etc.

In addition, each of the memories 116 and 136 may include both volatile and nonvolatile memory components. Volatile components are those that do not retain data values upon loss of power. Nonvolatile components are those that retain data upon a loss of power. Thus, each of the memories 116 and 136 may comprise, for example, random access memory (RAM), read-only memory (ROM), hard disk drives, floppy disks accessed via an associated floppy disk drive, compact discs accessed via a compact disc drive, magnetic tapes accessed via an appropriate tape drive, and/or other memory components, or a combination of any two or more of these memory components. In addition, the RAM may comprise, for example, static random access memory (SRAM), dynamic random access memory (DRAM), or magnetic random access memory (MRAM) and other such devices. The ROM may comprise, for example, a programmable read-only memory (PROM), an erasable programmable read-only memory (EPROM), an electrically erasable programmable read-only memory (EEPROM), or other like memory device.

Also, each of the processors 113 and 133 may represent multiple processors and each of the memories 116 and 136 may represent multiple memories that operate in parallel processing circuits, respectively. In such a case, each of the local interfaces 119 and 139 may be an appropriate network that facilitates communication between any two of the multiple processors, between any processor and any of the memories, or between any two of the memories, etc. The processors 113 and 133 may be electrical or optical in nature.

The operating systems 123 and 143 are executed to control the allocation and usage of hardware resources in the server 103 and the client 106, respectively. Specifically, the operating systems 123 and 143 control the allocation and usage of various portions of the memories 116 and 136, processing time, and the peripheral devices as well as performing other functionality. In this manner, the operating systems 123 and 143 serve as the foundation on which applications depend as is generally known by those with ordinary skill in the art.

Next a general discussion of the operation of the remote rendering network 100 is provided. To begin, a user of the client 106 wishes to print the document 149 using an attached printer or other printer associated with the client 106. Assume however that the client 106 lacks the application that must be implemented to print out the document 149. In this respect, the client rendering control 146 determines that there is no application to print the document 149 on the client 106. The client rendering control then transmits the document 149 with a rendering request to the rendering service 126 on the server 103. The rendering service 126 is employed to render the document into a language that is native to the printer upon which the document is to be printed.

To accomplish the transmission of the rendering request to the server 103, the client 106 may act as a hypertext transfer protocol (HTTP) server to serve up the rendering request to the server 103. Alternatively, another protocol may be employed to transfer the document 149 to the server 103 such as, for example, electronic mail or other transport device.

Upon receiving the document, the rendering service 126 proceeds to perform various rendering operations and other functionality according to the present invention to render the document in a format native to the printer upon which it is to be printed. In this regard, the rendering service 126 may employ various rendering applications such as, for example, Microsoft Word created by Microsoft Corporation of Redmond, Wash.; Adobe Acrobat created by Adobe Systems of Palo Alto, Calif.; Word Perfect created by Corel Corporation limited of Ottawa, Ontario, Canada, or other rendering applications that perform various rendering tasks. In addition, the rendering service 126 may employ various printer drivers to render the document 149 into the language native to the printer upon which the document 149 is to be printed.

The rendering request from the client 106 includes all necessary information that enables the rendering service 126 to perform the specific rendering tasks. For example, the rendering request may include the name of the printer upon which the document 149 is to be printed, the name of the input document file embodying the document 149, the name of the output document file that embodies the document 149 in the native language of the printer, any print options associated with the document 149, and any other necessary information. Once the document 149 has been rendered into the native language of the respective printer, the rendering service 126 then transmits back the rendered document to the client 106. The client 106 then may proceed to print the document using the designated printer.

The functionality of the client rendering control 146 is similar in many respects to the same entity described in co-pending the United States Patent Application entitled “Rendering Broker Service and Method” filed under attorney docket number 10010867-1 on even date herewith. This entire application including drawings is incorporated herein by reference. As such, a detailed description of the client rendering control 146 is omitted herein.

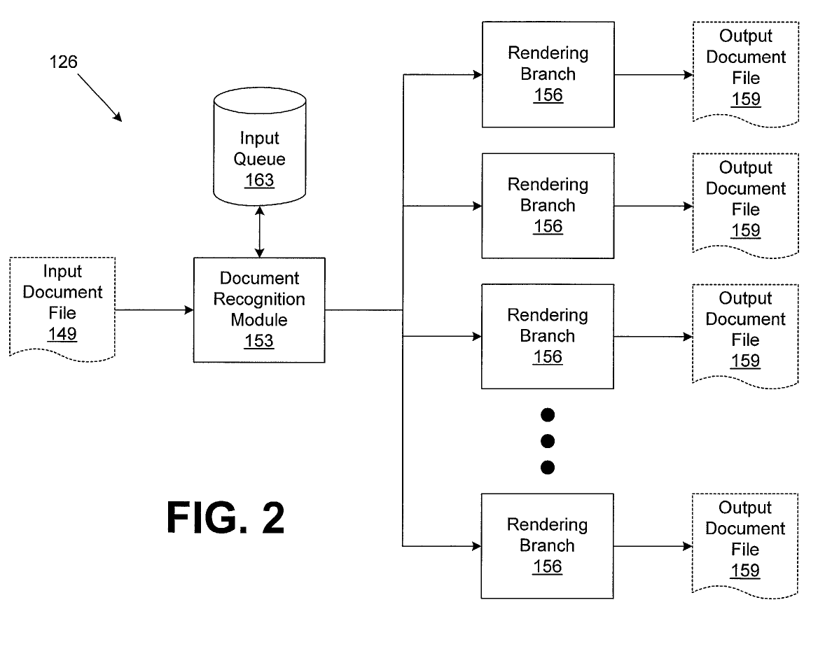

With reference to FIG. 2, shown is a functional block diagram of the rendering service 126 according to an aspect of the present invention. As shown in FIG. 2, each box represents a module, object, or other grouping or encapsulation of underlying functionality as implemented in programming code. However, the same underlying functionality may exist in one or more modules, objects, or other groupings or encapsulations that differ from those shown in FIG. 2 without departing from the present invention as defined by the appended claims.

As shown, the input document file 149 that is received by the rendering service 126 in a rendering request from the client 106 (FIG. 1) is processed by a document recognition module 153. The document recognition module 153 applies one or more input files 149 received from various clients 106 to one or more rendering branches 156. The rendering branches 156 are executed to automatically render the input document file 149 into an output document file 159. In doing so, each of the rendering branches 156 employs a particular rendering application to perform the rendering of the input document file 149 into the appropriate output document file 159.

The input document file 149 is embodied in a predefined file format native to the application that was used to generate the input document file 149 itself. The output document file 149 is embodied in a predefined file format that was generated by a select one of the rendering applications associated with a respective rendering branch 156. In this respect, the predefined file format of the output document file 159 may be embodied, for example, in a language native to a printer upon which the output document file 159 is to be printed. Thus, each rendering branch 156 performs predefined rendering operations in order to generate the output document file 159 in the desired file format. In doing so, each of the rendering branches 156 may employ a specific printer driver or other system. In this respect, the rendering of a document for printing, for example, is performed remotely from the client 106 (FIG. 1) upon which the document had been created.

The rendering service 126 also includes an input queue 163 that stores input document files 149 as they are received by the rendering service 126. In this manner, the input queue 163 is employed as a buffer when the number of rendering branches 156 employed at a given time is the maximum allowed. Specifically, the maximum parallel rendering operations allowed is related to a maximum amount of the available processing power of the server 103 (FIG. 1) as can be appreciated by those with ordinary skill in the art.

To describe the general operation of the rendering service 126, first, an input document file 149 is either directly applied by the document recognition module 156 or the document recognition module 156 pulls the same from the input queue 163. The document recognition module 153 then examines the input document file 149 to identify either the format of the input document file 149 or the application that was employed to generate the input document file 149. That is to say, the language or format in which the input document file 149 is embodied is native to the particular application used in its generation. If possible, the precise application used to generate the input document file 149 is determined so as to ascertain precisely what rendering applications are to be employed to render the output document file 159 for printing. For example, if the input document file 149 is embodied in a format employed by Microsoft Word, then Microsoft Word is identified as the rendering application to perform the needed rendering operations. Note the detailed functionality of Microsoft Word or other rendering applications is generally understood by those with ordinary skill in the art and not discussed herein in detail. In situations where the input document file 149 is embodied in an application independent format, then the document recognition module 153 attempts to determine the format alone.

After the document recognition module 153 identifies the application that was employed to generate the input document file 149 or the native format of the input document file 149, the document recognition module 153 determines the precise rendering application that is to be employed to render the input document file 149 into the output document file 159. In this respect, the desired format of the output document file 159 is communicated to the rendering service 126 from the client 106 in the rendering request. For example, the specific printer upon which the output document file 159 is to be printed may be identified in the rendering request. This information is employed by the rendering application, for example, to determine which driver is to be used to render the document in the language native to the printer.

Thus, a predetermined rendering application is associated with each one of the rendering branches 156. In order to determine which rendering branch 156 is to be employed to render the input document file 149 to the output document file 159, the document recognition module 153 may consult a lookup table or database, for example, that lists the various rendering applications as well as their respective rendering capabilities. Once the rendering application is identified from the number of rendering applications that are associated with the rendering service 126 (FIG. 2), the document recognition module 153 applies the input document file 149 to the respective rendering branch 156. The input document file 149 is applied along with a render command that the rendering branch 156 perform the rendering operation necessary to convert the input document file 149 to the output document file 159. The render command includes all necessary information for the rendering branch 156 to identify and perform all necessary rendering operations.

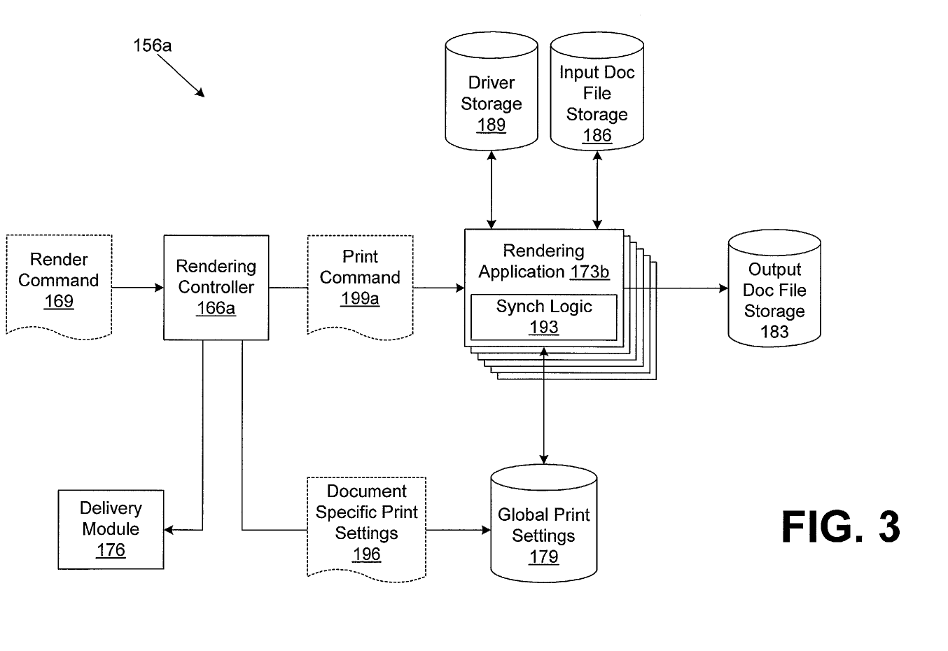

With reference to FIG. 3, shown is a functional block diagram of an embodiment of a rendering branch 156a according to an aspect of the present invention. As shown in FIG. 3, each box represents a module, object, or other grouping or encapsulation of underlying functionality as implemented in programming code. However, the same underlying functionality may exist in one or more modules, objects, or other groupings or encapsulations that differ from those shown in FIG. 3 without departing from the present invention as defined by the appended claims.

The rendering branch 156a is implemented to render the input document file 149 into the output document file 159 (FIG. 2) as was described with reference to FIG. 2. In this respect, the rendering branch 156a includes a rendering controller 166a that receives the render command 169 from the document recognition module 153 (FIG. 2). The rendering controller 166a is associated with a predetermined rendering application 173a. The rendering application 173a may comprise, for example, Microsoft Word created by Microsoft Corporation of Redmond, Wash., Adobe Acrobat created by Adobe Systems of Palo Alto, Calif., Word Perfect created by Corel Corporation limited of Ottawa, Ontario, Canada, or other applications that perform rendering operations in printing documents.

The rendering branch 156a also includes a delivery module 176, global print settings 179, an output document file storage location 183, an input document file storage location 186, and a driver storage location 189. Each of the rendering applications 173a includes synchronization logic 193, the function of which will be discussed.

The rendering branch 156a includes a rendering application 173a that employs global print settings 179 to provide for specification of printing options for the application 173. The rendering application 173a is instantiated for each input document file 149 to be rendered. However, the global print settings 179 apply to all instances of the rendering application 173a as can be appreciated by those with ordinary skill in the art.

With this in mind, the operation of the rendering branch 156a is described. To begin, the render command 169 is provided from the document recognition module 153 to the rendering controller 166a. Also, the input document file 149 associated with the render command 169 is stored in the input document file storage 186, the render command 169 containing a reference thereto so that the rendering controller 166a may find it. Upon receipt of the render command 169, the rendering controller 166a then proceeds to rewrite the global print settings 179 with document specific print settings 196 that are associated with the input document file 149 to be rendered. Specifically, the original global print settings 179 provided with the rendering application 173a are temporarily stored and then replaced with the document specific print settings 196 that are provided in the rendering request from the client 106 (FIG. 1). The document specific print settings 196 are thus employed as the print settings 179 during the implementation of a rendering operation with an instantiation of the rendering application 173a as will be discussed.

The document specific print settings 196 may comprise, for example, the input filename of the input document file 149 and its location in the input document file storage 186. The document specific print settings 196 may also include the output filename that is to be associated with the resulting output document file 159. In addition, a printer name of a printer that is ultimately to be used to print the output document file 159 may be included in the document specific print settings 196. The printer name is included so that the rendering application 173a can identify the precise driver stored in the driver storage 189 that is to be employed in rendering the document in the language native to the printer to be employed to print the document. In addition, various print options may also be included in the document specific print settings 196 that are employed by the rendering application 173a. Specifically, the print options may be, for example, the number of copies of the document, the orientation of the document (i.e. landscape or portrait), the print quality of the document may be specified, as well as other parameters as may be appreciated with those with ordinary skill in the art.

Once the global print settings 179 have been rewritten with the document specific print settings 196, the rendering controller 166a launches an instance of the rendering application 173a. The rendering controller 166a then generates a print command 199a that is applied to the instance of the rendering application 173a. In this respect, the rendering controller 166a causes the rendering application 173a to perform its normal printing operation to print the document based upon the global print settings 179. Upon receiving the print command 199a, the synchronization logic 193 within the instance of the rendering application 173a communicates with similar synchronization logic 193 and all other open instances of the rendering application 173a to ensure that no other rendering application 173a attempts to commence a rendering operation, thereby freezing the state of the global print settings 179. Thus the synchronization logic 193 prevents a collision between different instances of the rendering application 173a in changing the global print settings 179 before one or the other has had the opportunity to implement a rendering function with their own desired global print settings 179.

The time period at which a collision might occur in this respect exists between the time that the global print settings 179 have been set for a particular document and the time of the launching of the instance of the rendering application 173a. This is because at the time that the rendering application 173a is launched, it makes a local copy of the current global print settings 179 to employ in rendering the specific document. In this manner, the rendering application 173a determines the precise nature of the ultimate output document file 159 based upon the input file name, the output file name, and the printer name, as well as though any print options included in the global print settings 179. Once such information has been consulted by the rendering application 173a and the corresponding rendering operations have commenced, then the global print settings 179 may be altered for another instance of the rendering application 173a in rendering another input document file 149. Once the rendering operations are complete, the global print settings 173a are restored to their original values.

In performing the rendering operations, the rendering application 173a may employ a specific driver associated with the printer upon which the output document file 159 is to be printed. Once the rendering application 173a has completed its rendering operations, the output document file 159 is placed in the output document file storage 183. Upon being informed that the rendering application 173a has completed its operation, the rendering controller 166a then communicates with the delivery module 176 that performs the tasks necessary to deliver the output document file 159 to the client 106 that ultimately requested the rendering of the input document file 149.

In this respect, the output document file 159 is transmitted to the client 106 by the delivery module 176. Note that the delivery module 176 may transmit the output document file 159 to the client 106 in one of several ways. For example, the output file 159 may be placed in a file server within the server 103 and the client 106 may repeatedly poll the file server to inquire as to whether or not the document has been rendered and is ready to download to the client 106. In this respect, the server 103 may serve up the output document file 159 once it has been created and stored in the respective location in the memory 116 to the client 106. As such, the server 103 may operate as an HTTP server and the client 106 may operate as an HTTP client as is generally known by those with ordinary skill in the art. Note that this may be desirable in such cases where the server 103 or the client 106 resides behind a firewall or other security setup as is generally known by those with ordinary skill in the art. Alternatively, the delivery module 176 may transmit the output document file 159 directly to the client 106 using a predefined protocol such as electronic mail as is generally known by those with ordinary skill in the art. Further, other protocols may be employed such as the Simple Object Access Protocol or other protocols.

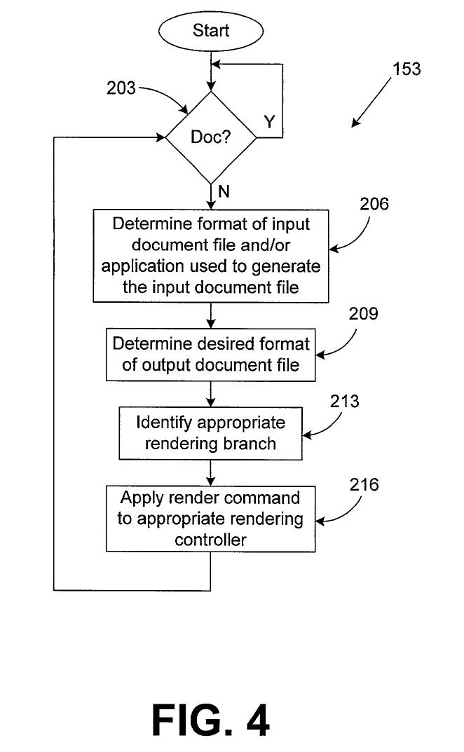

With reference to FIG. 4, shown is a flowchart of the document recognition module 153 according to an aspect of the present invention. Alternatively, the flow chart of FIG. 4 may be viewed as depicting steps in a method implemented in the server 103 (FIG. 1).

Beginning with box 203, the document recognition module 153 waits to receive a new input document file 149 (FIG. 2) to be rendered. Note that the input document file 149 may be received directly or may have been placed in the input queue 163 (FIG. 2). Assuming that there is an input document file 149 to render, the document recognition module 153 proceeds to box 206 in which the native language or format of the input document file 149 is determined. In determining the native format of the input document file 149, the document recognition module 153 may identify the application that was employed to generate the input document file 149, where such application may be employed as one of the rendering applications 173a (FIG. 3). Alternatively, the specific format of the input document file 149 is determined in the case that the input document file 149 is in an application independent format. Thereafter, in box 209, the desired format of the output document file 159 (FIG. 2) is determined. This may be identified, for example by examining information included within the rendering request transmitted by client 106 (FIG. 1). Alternatively, the desired format of the output document file 159 may be determined by identifying the printer that was designated by the client 106 in which the output file 159 is ultimately to be printed. Specifically, the format of the output document file 159 is that which employs the native language of the named printer.

Once the desired format of the output document file 159 is known, the document recognition module 153 proceeds to box 213 in which it identifies an appropriate rendering branch 156 (FIG. 2) to process the input document file 149. Specifically, the document recognition module 153 identifies the rendering application 173a (FIG. 3) associated with the respective rendering branch 156 that is to be used to render the input document file 149 into the output document file 159. This may be done, for example, by consulting a lookup table or database where various types of rendering applications 173a that may be employed are stored. Thereafter, in box 216, a render command 169 (FIG. 3) is generated and supplied to the rendering controller 166a to render the respective input document file 149 into the output document file 159. The render command includes a reference to the input document file 149 in terms of its uniform resource locator that points to its location in the input file storage 186 (FIG. 3). Thereafter, the document recognition module 153 reverts back to box 203.

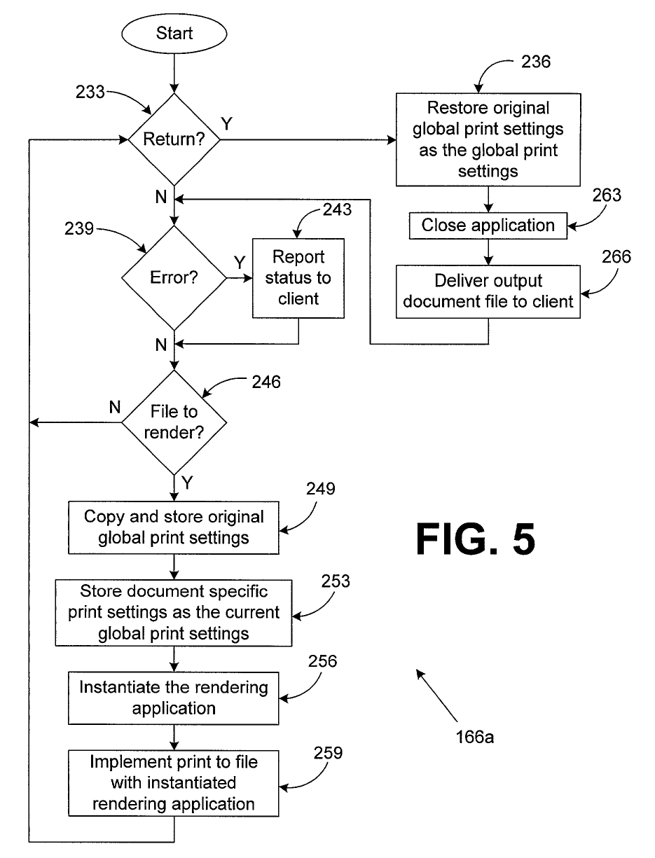

With reference to FIG. 5, shown is a flow chart of the rendering controller 166a according to an aspect of the present invention. Alternatively, the flow chart of FIG. 5 may be viewed as depicting steps implemented in the server 103 with respect to the rendering process as described. Beginning with box 233, the rendering controller 166a determines whether it has received a message from an instance of the rendering application 173a that it has completed a rendering process associated with a particular input document file 149. If such is the case then the rendering controller 166a proceeds to box 236, otherwise the rendering controller 166a proceeds to box 239. Note that the progression of events following box 236 will be described in later text.

In box 239, the rendering controller 166a determines whether an error has occurred such that the input document file 149 cannot be rendered into the output document file 159 as desired by the client 106. Note that any number of events may occur that would cause such an error condition such as, for example, if an appropriate rendering application 173a is unavailable. If such is the case, then the rendering controller 166a proceeds to box 243 in which an appropriate status report is provided to the client 106 regarding the error condition. Note that the status report that is provided to the client 106 may be transmitted to the client 106 in a manner similar to the transmission of the output document file 159 as can be appreciated by those with ordinary skill in the art.

From boxes 239 or 243, the rendering controller 166a proceeds to box 246 to determine whether there is an existing input document file 149 that is to be rendered. Such is known when the render command 169 has been received from the document recognition module 153. Assuming that there is no input document file 149 to render in box 246, the rendering controller 166a reverts back to box 233. Otherwise, the rendering controller 166a proceeds to box 249.

In box 249, the rendering controller 166a copies the original global print settings 179 and stores them at a predetermined location in the memory 116 (FIG. 1). This is done so as to maintain the original global print settings so that they are not lost in future processing. Then, in box 253, the global print settings 170 are rewritten as the document specific print settings 196 (FIG. 3). Thereafter, in box 256 the rendering controller 166a instantiates the rendering application 173a in order to render the respective input document file 149. Then, in box 259, the print command 199a is provided to the particular instance of the rendering application 173a in such that the rendering application 173a then performs all rendering functions to print the input document file 149 to the output document file 159 that is then stored in the output document file storage 183. In this respect, the print command 199a may include, for example, a reference to the input document file 149. Thereafter, the rendering controller 166a reverts back to box 233.

Referring back to box 236, upon being informed by a specific instance of the rendering application 173a that a respective input document file 149 has been rendered to the output document file 159, the rendering controller 166a restores the original global print settings associated with rendering application 173a. Thereafter, the rendering controller 166a closes the particular instance of the rendering application 173a that is completed its rendering operation. Thereafter, the rendering controller 166a proceeds to box 266 in which the output document file is provided to the client 106 (FIG. 1). This may be done, for example, by initiating the document delivery operations of the delivery module 176 (FIG. 3). Thereafter, the rendering controller 166a proceeds to box 239 as shown.

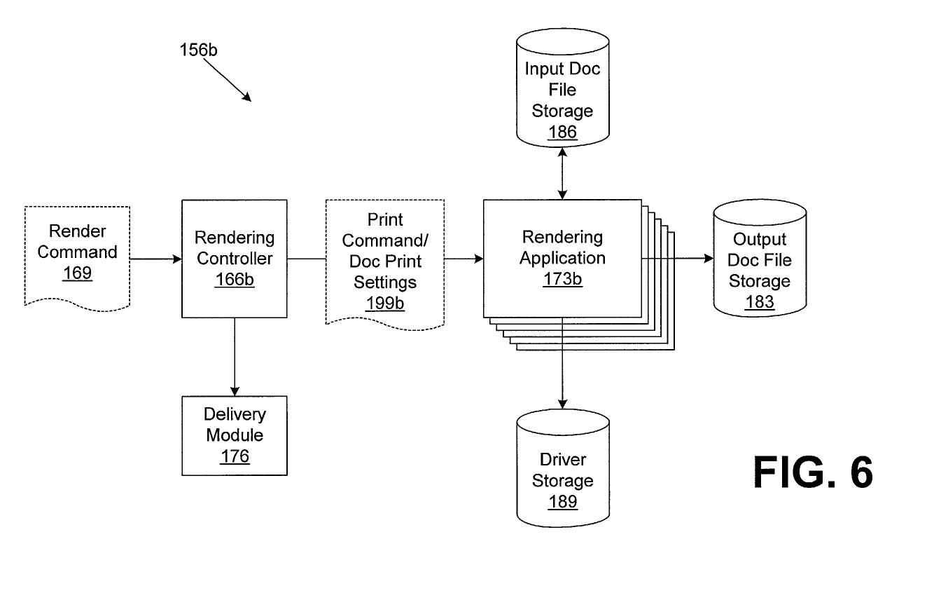

With reference to FIG. 6, shown is a functional block diagram of a second embodiment of a rendering branch 156b according to an aspect of the present invention. As shown in FIG. 6, each box represents a module, object, or other grouping or encapsulation of underlying functionality as implemented in programming code. However, the same underlying functionality may exist in one or more modules, objects, or other groupings or encapsulations that differ from those shown in FIG. 6 without departing from the present invention as defined by the appended claims.

The rendering branch 156b differs from the rendering branch 156a (FIG. 3) in that the global print settings 179 (FIG. 3) are not employed. Specifically, print settings associated with each document are employed with each instance of the rendering application 173b. To begin, the rendering branch 156b receives the render command 169 from the document recognition module 153 (FIG. 2) to render a particular input document file 149 (FIG. 2) into a respective output document file 159. The render command 169 contains the various print settings that are to be associated with the rendering of the respective input document file 149.

Specifically, these print settings may include, for example, the filename of the input document file 149, the filename of the output document file 159, the printer name, and any print options that are associated with the printing of the input document file 149. The rendering controller 166b then instantiates the rendering application 173b to perform the rendering operation. The rendering controller 166b then applies the print command/print settings 199b to the rendering application 173b. The print command/print settings 199b identifies the location and name of the input document file 149.

The rendering application 173b then proceeds to render the document into the output document file 159. In doing so, the rendering application 173b may call upon a particular driver stored in the driver storage 189 to perform various functions in rendering the input document file 149 into the output document file 159 where the output document file 159 is to be embodied in a language native to a printer upon which the document is to be printed. Once the output document file 159 has been created, the rendering controller 166b transmits of the output document file 159 to the client 106 (FIG. 1) by executing the functions of the delivery module 176. In addition, the rendering controller 166b generates and transmits any error and/or other status messages generated to be provided to the client 106 with regard to the rendering of the input document file 149 into the respective output document file 159.

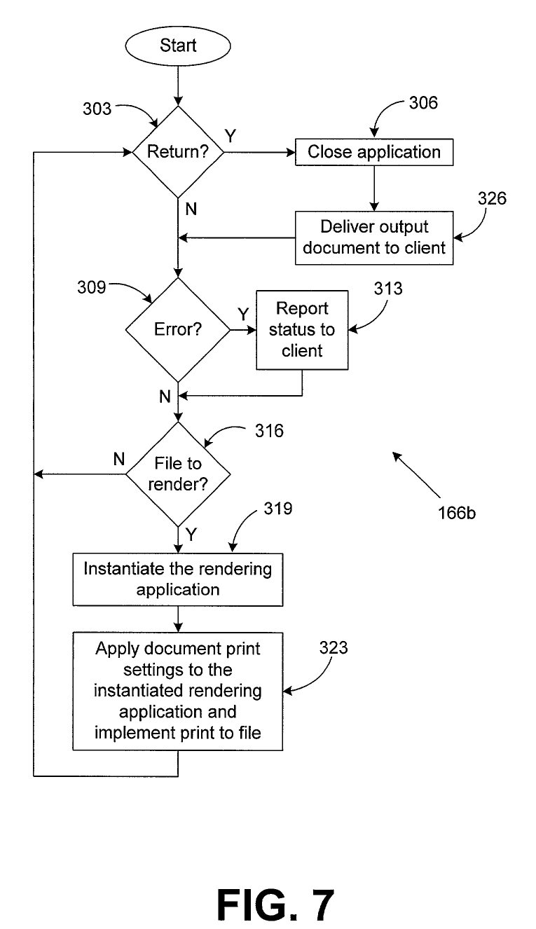

With reference to FIG. 7, shown is a flow chart of the rendering controller 166b according to an aspect of the present invention. Alternatively, the flow chart of FIG. 7 may be viewed as depicting steps in a method implemented in the server 103 (FIG. 1). Beginning with box 303, the rendering controller 166b determines whether a specific instance of the rendering application 173b (FIG. 6) has completed its rendering operations. If such is the case, then the rendering controller 166b moves to box 306 in which the respective instance of the rendering application 173b is closed. Otherwise, the rendering controller 166b proceeds to box 309.

In box 309, the rendering controller 166b determines whether any error conditions or other status conditions may exist that are to be communicated to the client device 106 (FIG. 1). If such is the case then the rendering controller 166b proceeds to box 313 in which a status report that reports either the error or other status is transmitted to the client 106 in a manner previously described. From boxes 309 or 313, the rendering controller 166b proceeds to box 316 in which it is determined whether a render command 169 has been received from the document recognition module 153 (FIG. 2) informing the rendering controller 166b that a respective input document file 149 is to be rendered.

The render command 169 may include, for example all document print settings including, for example, the filename of the input document file 149, the filename of the output document file 159, the name of the printer on which the output document file is to be printed, and any print options associated with the document that are to be employed by the rendering application 173b. Note other information may be included as well.

If a render command 169 has not been received in box 316, then the rendering controller 166b reverts back to box 303. However, if there is a new input document file 149 to be rendered, the rendering controller 166b proceeds to box 319 to instantiate the rendering application 173b in order to process the respective input document file 149. Thereafter, in box 323, the print command 199b that includes the document print settings are applied to the instance of the rendering application 173b to implement the print to file function. The rendering application 173b then performs those functions necessary to render the document for printing to the output document file 159. In doing so, the rendering application 173b may employ a respective driver stored in the driver storage 189. Once the output document file 159 has been created and stored in the output document file storage 183 (FIG. 6), the rendering controller 166b reverts back to box 303.

Referring back to box 306, assuming that a respective rendering application 173b has completed the rendering operations, thereby creating a respective output document file 159, then the rendering controller 166b proceeds to box 306 to close the respective instance of the rendering application 173b. Thereafter the rendering controller 166b proceeds to box 326 in which the output document file 159 is delivered to the client 106. Note that this may involve calling the functions of the delivery module 176 to perform the various transmission tasks that are necessary as was described with reference to previous embodiments.

Although the document recognition module 153, rendering controllers 166a/166b, and other components of the present invention may be embodied in software or code executed by general purpose hardware as discussed above, as an alternative the same may also be embodied in dedicated hardware or a combination of software/general purpose hardware and dedicated hardware. If embodied in dedicated hardware, the document recognition module 153, rendering controllers 166a/166b, and/or other components can be implemented as a circuit or state machine that employs any one of or a combination of a number of technologies. These technologies may include, but are not limited to, discrete logic circuits having logic gates for implementing various logic functions upon an application of one or more data signals, application specific integrated circuits having appropriate logic gates, programmable gate arrays (PGA), field programmable gate arrays (FPGA), or other components, etc. Such technologies are generally well known by those skilled in the art and, consequently, are not described in detail herein.

The block diagrams and flow charts of FIGS. 2-7 show the architecture, functionality, and operation of an implementation of the document recognition module 153, rendering controllers 166a/166b, and other components. If embodied in software, each box may represent a module, segment, or portion of code that comprises program instructions to implement the specified logical function(s). The program instructions may be embodied in the form of source code that comprises human-readable statements written in a programming language or machine code that comprises numerical instructions recognizable by a suitable execution system such as a processor in a computer system or other system. The machine code may be converted from the source code, etc. If embodied in hardware, each box may represent a circuit or a number of interconnected circuits to implement the specified logical function(s).

Although the block diagrams and flow charts of FIGS. 2-7 show a specific order of execution, it is understood that the order of execution may differ from that which is depicted. For example, the order of execution of two or more boxes may be scrambled relative to the order shown. Also, two or more boxes shown in succession in FIGS. 4, 5 and 7 may be executed concurrently or with partial concurrence. In addition, any number of counters, state variables, warning semaphores, or messages might be added to the logical flow described herein, for purposes of enhanced usability, accounting, performance measurement, or providing troubleshooting aids, etc. It is understood that all such variations are within the scope of the present invention. Also, the block diagrams and flow charts of FIGS. 2-7 are relatively self-explanatory and are understood by those with ordinary skill in the art to the extent that software and/or hardware can be created by one with ordinary skill in the art to carry out the various logical functions as described herein.

Also, where the document recognition module 153, rendering controllers 166a/166b, and other components comprise software or code, they may be embodied in any computer-readable medium for use by or in connection with an instruction execution system such as, for example, a processor in a computer system or other system. In this sense, the logic may comprise, for example, statements including instructions and declarations that can be fetched from the computer-readable medium and executed by the instruction execution system. In the context of the present invention, a “computer-readable medium” can be any medium that can contain, store, or maintain the document recognition module 153, rendering controllers 166a/166b, and other components for use by or in connection with the instruction execution system. The computer readable medium can comprise any one of many physical media such as, for example, electronic, magnetic, optical, electromagnetic, infrared, or semiconductor media. More specific examples of a suitable computer-readable medium would include, but are not limited to, magnetic tapes, magnetic floppy diskettes, magnetic hard drives, or compact discs. Also, the computer-readable medium may be a random access memory (RAM) including, for example, static random access memory (SRAM) and dynamic random access memory (DRAM), or magnetic random access memory (MRAM). In addition, the computer-readable medium may be a read-only memory (ROM), a programmable read-only memory (PROM), an erasable programmable read-only memory (EPROM), an electrically erasable programmable read-only memory (EEPROM), or other type of memory device.

Although the invention is shown and described with respect to certain preferred embodiments, it is obvious that equivalents and modifications will occur to others skilled in the art upon the reading and understanding of the specification. The present invention includes all such equivalents and modifications, and is limited only by the scope of the claims.

What is claimed is:

1. A rendering method, comprising:
identifying an application employed to generate a digital document in a computer system;
identifying a select rendering application from a number of rendering applications in the computer system to render the document into an output file embodied in a predefined file format; and
automatically rendering the digital document into the output file embodied in the predefined file format with the select rendering application.

2. The rendering method of claim 1, further comprising the step of receiving the digital document from a client device along with a rendering request.

3. The rendering method of claim 1, further comprising the step of transmitting the digital document rendered in the output file embodied in the predefined file format to a client device.

4. The rendering method of claim 1, wherein the step of automatically rendering the digital document into the output file in the predefined file format with the select rendering application further comprises rendering the digital document into a printer compatible output file embodied in a language native to a predefined printer.

5. The rendering method of claim 1, wherein the step of automatically rendering the digital document into the output file in the predefined file format with the select rendering application further comprises:
setting a global print setting associated with the select rendering application to print to the output file;
generating an instance of the select rendering application to automatically render the digital document into the output file; and
commanding the instance of the select rendering application to perform a print operation on the digital document.

6. The rendering method of claim 5, wherein the step of setting the global print setting associated with the select rendering application to print to the output file further comprises rewriting a global print setting associated with a number of instances of the select rendering application for printing to the output file.

7. The rendering method of claim 6, further comprising synchronizing an initiation of the print operation of the instance of the select rendering application with a number of other initiations of print operations for other instances of the select rendering application.

8. A program embodied in a computer readable medium for document rendering, comprising:
code that identifies an application employed to generate a digital document in a computer system;
code that identifies a select rendering application from a number of rendering applications in the computer system to render the document into an output file embodied in a predefined file format; and
code that automatically executes the select rendering application to render the digital document into the output file embodied in the predefined file format.

9. The program embodied in a computer readable medium of claim 8, wherein the code that automatically executes the select rendering application to render the digital document into the output file embodied in the predefined file format further comprises code that automatically executes the select rendering application to render the digital document into the output file embodied in a language native to a predefined printer.

10. The program embodied in a computer readable medium of claim 8, wherein the code that automatically executes the select rendering application to render the digital document into the output file embodied in the predefined file format, further comprises:
code that sets a global print setting associated with the select rendering application to print to the output file;
code that generates an instance of the select rendering application; and
code that applies a command to the instance of the select rendering application to perform a print operation on the digital document.

11. The program embodied in a computer readable medium of claim 10, wherein the code that sets the global print setting associated with the select rendering application to print to the output file further comprises code that rewrites a global print setting associated with a number of instances of the select rendering application for printing to the output file.

12. The program embodied in a computer readable medium of claim 11, further comprising code that synchronizes an initiation of the print operation of the instance of the select rendering application with a number of other initiations of print operations for other instances of the select rendering application.

13. A rendering system, comprising:
a processor circuit having a processor and a memory;
a rendering service executable by the processor and stored in the memory, the rendering service comprising:
logic that identifies an application employed to generate a digital document in a computer system;
logic that identifies a select rendering application from a number of rendering applications in the computer system to render the document into an output file embodied in a predefined file format; and
logic that automatically executes the select rendering application to render the digital document into the output file embodied in the predefined file format.

14. The rendering system of claim 13, wherein the logic that automatically executes the select rendering application to render the digital document into the output file embodied in the predefined file format further comprises logic that automatically executes the select rendering application to render the digital document into the output file embodied in a language native to a predefined printer.

15. The rendering system of claim 13, wherein the logic that automatically executes the select rendering application to render the digital document into the output file embodied in the predefined file format, further comprises:
logic that sets a global print setting associated with the select rendering application to print to the output file;
logic that generates an instance of the select rendering application; and
logic that applies a command to the instance of the select rendering application to perform a print operation on the digital document.

16. The rendering system of claim 15, wherein the logic that sets the global print setting associated with the select rendering application to print to the output file further comprises logic that rewrites a global print setting associated with a number of instances of the select rendering application for printing to the output file.

17. The rendering system of claim 16, further comprising logic that synchronizes an initiation of the print operation of the instance of the select rendering application with a number of other initiations of print operations for other instances of the select rendering application.

18. A rendering system, comprising:
means for identifying an application employed to generate a digital document in a computer system;
means for identifying a select rendering application from a number of rendering applications in the computer system to render the document into an output file embodied in a predefined file format; and
means for automatically executing the select rendering application to render the digital document into the output file embodied in the predefined file format.

19. The rendering system of claim 18, wherein the means for automatically executing the select rendering application to render the digital document into the output file embodied in the predefined file format further comprises means for automatically executing the select rendering application to render the digital document into the output file embodied in a language native to a predefined printer.

20. The rendering system of claim 18, wherein the means for automatically executing the select rendering application to render the digital document into the output file embodied in the predefined file format, further comprises:
means for setting a global print setting associated with the select rendering application to print to the output file;
means for generating an instance of the select rendering application; and
means for applying a command the instance of the select rendering application to perform a print operation on the digital document.
